(19) United States
(12) Patent Application Publication
(10) Pub. No.: US 2008/0091607 A1
(43) Pub. Date: Apr. 17, 2008

(54) Commercial web

(75) Inventor: Dean P. Alderucci, Westport, CT (US)

Correspondence Address: FOLEY HOAG, LLP;PATENT GROUP, WORLD TRADE CENTER WEST, 155 SEAPORT BLVD, BOSTON, MA, 02110, US

(73) Assignee: Cantor Fitzgerald LP/eSpeed, Inc., New York, NY (US)

(21) Appl. No.: 11/580,688

(22) Filed: Oct. 13, 2006

(51) Int. Cl. H04L 9/00

(52) U.S. Cl. 705/51

(57) ABSTRACT

Provided are methods and systems for operating a web-based data service in which paying users receive a benefit for content provided to the service.

### DETAILED DESCRIPTION

Operators of data services such as Reuters, Lexis-Nexis, and the like are always interested in enhancing the amount and quality of their content, as well as in providing content that users find relevant. Allowing users to provide content in exchange for a benefit is one such way to increase the amount and relevancy of content provided by a data service to its users. Users are also more likely to be interested in something over which they have some control.

Accordingly, provided are methods and systems for operating a web-based data service in which paying users receive a benefit for content provided to the service.

Definitions

For convenience, before further description of the invention, certain terms employed in the specification, examples, and appended claims are collected here. Unless defined otherwise, all technical and scientific terms used herein have the same meaning as commonly understood by one of ordinary skill in the art to which this invention belongs.

The articles “a” and “an” are used herein to refer to one or to more than one (i.e., to at least one) of the grammatical object of the article.

The phrase “based on” does not mean “based only on”, unless expressly specified otherwise. In other words, the phrase “based on” describes both “based only on” and “based at least on”.

The term “clean” refers to any process of detecting and correcting errors in data. For example, “cleaning” may include checking data for adherence to standards, internal consistency, referential integrity, valid domain, removing duplicates or irrelevant data, and replacing/repairing incorrect data with correct data. Methods of cleaning may include, but are not limited to, checking data quality and scrubbing data by some combination of: look-up against valid data (e.g. a list of 140 million US mailing addresses), look-up against domain values (e.g. a list of valid US State and Territory codes), domain range checks (e.g. employees less than 15 or greater than 90 years old), consistency checks among table data, pattern analysis of exceptions, correlations, and frequency distributions.

The term “content” refers to the information provided on a web page, as opposed to its design and layout. For example, content includes video (visual images), audio (audible sounds), podcast (downloadable audio and/or files), transaction data (data collected in connection with a transaction), chat rooms (internet sites where a number of users can communicate in real time), analysis, research reports, articles, rumors (a statement or report without known authority for its truth), market data (data collected about the markets), news, modeling systems (web-based tool for modeling and simulating various phenomena), advertisements, games, weather reports and forecasts, and derivative data (data derived from any of the content described above).

The term “subscription” refers to an arrangement for providing, receiving, or making use of something of a continuing or periodic nature on a prepayment plan.

The terms “including”, “comprising” and variations thereof mean “including but not limited to”, unless expressly specified otherwise.

Methods of Operating a Web-Based Data Service

Provided are methods and systems for operating a web-based data service in which paying users receive a benefit for content provided to the service. The data service may be accessible via a web interface, and/or via another program such as a customer application or RSS data reader. There can be an API to allow a program written to access the content. Further, the web interface may include redirectors.

In one embodiment, a method may comprise (a) receiving a fee from at least one user; (b) providing content to the users from whom a fee is received; (c) receiving content from at least one user from whom a fee is received; and (d) providing a benefit to the users from whom content is received based at least in part on the content received from the user.

In another embodiments, a method may comprise: (a) paying a fee; (b) viewing content in return for paying the fee; (c) providing content in return for paying the fee; and (d) receiving a benefit based at least in part on the content provided.

The benefit may be, for example, a payment to the user. For example, the payment may be given as a credit against the fee received from the user. However, any benefit may be provided to an entity, such as a user, that provides content. For example, an entity that provides content to the data service can be provided with lower fees or no fees. In data services which operate using brokerage commissions, lower brokerage commissions or no brokerage commissions may be the benefit. Similarly, an entity that provides content to the data service can be provided with reduced or eliminated brokerage commissions or other types of fees, provided that the entity consumes, that is, accesses data, related to the service or brokerage. For example, an entity that provides content to the data service may be provided with reduced or eliminated brokerage commissions on a trade of a U.S. Treasury Bill, provided that the entity accesses data that relates to the U.S. Treasury market on the data service.

In certain embodiments, where the company providing the data service may be taken public, entities that provide content may be provided with equity in the company as a benefit.

In embodiments where the benefit is a credit, the credit may be based on any number of factors, including (1) what type of content is contributed, (2) how much content is contributed, (3) how many entities access the contributed content, (4) how many accesses of the contributed content are made, (5) how much money entities pay to access the contributed content and/or (6) whether an entity contributing content has paid a fee, and if so, how much.

For example, the credit may be a fraction of the fee received from the user. In certain embodiments, the credit may not exceed a certain limit, that is, there is a maximum credit for providing content. For example, the credit for providing content may be no more than half of the subscription fee paid by the user. In such an example, where the fee is $400 per month per user, the credit could be up to $200 per month per user. Thus, a user that contributes sufficient content would pay only $200 per month for subscribing to the data service.

In certain embodiments, the credit may be a portion of an aggregation of all fees collected from entities that provide content. For example, 5% of all subscription fees may be allocated to a pool, and the pool distributed to entities that provide content to the data service.

In certain embodiments, only users who pay a certain type of fee may provide content. For example, in certain embodiments, only users paying a subscription fee (as opposed to a one-time fee for a one-time access of content), i.e. subscribers, may provide content. In other embodiments, only users paying the maximum fee charged on a scale of fees (e.g. different rates for academic institutions, small companies, large companies) for accessing content may provide content.

In certain embodiments, registration information may be obtained from a user contributing content.

In certain embodiments, the content contributed by an entity may be cleaned, e.g. by another entity. Accordingly, the methods may comprise cleaning the content received from users. In other embodiments, the methods may comprise sending the content to an entity to be cleaned and receiving the cleaned content from said entity.

The method may further comprise displaying the content. In certain embodiments, the consumption of content may be displayed (e.g., a pie chart or text). In other embodiments, the content contributed may be displayed, and how much credit is due from the contributed content.

In certain embodiments, the content may be rated. For example, the content may be rated based on accesses (e.g., the number of entities accessing the data, or the number of accesses per content). The rating may be applied currently and/or historically (e.g., most frequently accessed today, most frequently accessed this month, most frequently accessed this year, etc.). Similarly, the accesses and/or the rating of any content can be displayed, e.g., as an X-Y plot over time. A “ratings page” may show top-rated content (overall by category) to guide users interested in being guided to top content.

Further, there may be different ratings in different categories of content (e.g., the most popular financial content, most popular analyst reports). Content may fall into one or more categories of content.

Accordingly, in one embodiment, the methods may further comprise receiving ratings of the content and displaying the received ratings.

In certain embodiments, points may be assigned to content based on the content's ratings. The points assigned to certain contributed content can be used to calculate the credit due an entity that contributes the content (e.g., the credit itself, or a bonus payment in addition to the credit.) Points can be deleted based on poor performance on the content (e.g., less than a predetermined frequency of accesses by others is observed).

In other embodiments, a method may comprise (a) receiving content from at least one user; (b) providing a benefit to the users from whom content is received based at least in part on the content received from the user; and providing content to the users only if a condition is met.

In yet another embodiment, a method may comprise (a) providing content; (b) receiving a benefit based at least in part on the content provided; and (c) viewing content only if a condition is met.

Such methods provide “gated” access to the content. The user's or entity's access to the content may be conditioned on, for example, (1) the entity having contributed content to the data service, (2) the type of content contributed, (3) how much content is contributed, (4) how many entities access the contributed content, (5) how many accesses of the contributed content there are, (6) how much money entities pay to access the contributed content, and/or (7) whether the entity has paid a fee.

In certain embodiments, an alert may be sent to entities that contributed content if data theft is detected.

Systems for Implementation of the Methods of Operating a Web-Based Data Service

The methods of operating a web-based data service described above are preferably implemented as a browser-based system in which a program running on a user's computer (the user's web browser) requests information from a server program running on a system server. The system server sends the requested data back to the browser program and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following: the transfer protocol (e.g., http://); and the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Netscape®. Navigator available from Netscape® Communications Corporation and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the account management system described below and illustrated in the accompanying drawings.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, i.e. databases of content, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

We claim:

1. A method, comprising
a. receiving a fee from at least one user;
b. providing content to the users from whom a fee is received;
c. receiving content from at least one user from whom a fee is received; and
d. providing a benefit to the users from whom content is received based at least in part on the content received from the user.

2. The method of claim 1, wherein the benefit is a payment to the user, whereby the fee received from the user is the fee due less a credit.

3. The method of claim 2, wherein the credit is a portion of the fee received from the user.

4. The method of claim 2, wherein the credit does not exceed a predefined amount.

5. The method of claim 1, wherein c) comprises receiving content from a predefined type of user.

6. The method of claim 5, wherein the type of user is a subscriber.

7. The method of claim 5, wherein the type of user is a user paying the maximum fee on a fee scale.

8. The method of claim 1, wherein the content is selected from the group consisting of: video, audio, podcast, transaction data, chat rooms, analysis, research, articles, rumors, market data, news, modeling systems, advertising, games, weather reports and forecasts, and data derived from any of the foregoing.

9. The method of claim 1, further comprising e) cleaning the content received from users.

10. The method of claim 1, further comprising e) sending the content to an entity to be cleaned and f) receiving the cleaned content from said entity.

11. The method of claim 1, further comprising e) displaying the content.

12. The method of claim 1, further comprising e) receiving at least one rating of the content and f) displaying the at least one rating or a value calculated from the at least rating.

13. A method, comprising
a. receiving content from at least one user;
b. providing a benefit to the users from whom content is received based at least in part on the content received from the user; and
c. providing content to the users only if a condition is met.

14. A method, comprising
a. paying a fee;
b. viewing content in return for paying the fee;
c. providing content in return for paying the fee; and
d. receiving a benefit based at least in part on the content provided.

15. A method, comprising
a. providing content;
b. receiving a benefit based at least in part on the content provided; and
c. viewing content only if a condition is met.

16. A method, comprising:
a. receiving a subscription fee from at least one user;
b. providing content to the users from whom a subscription fee is received;
c. receiving content from at least one user from whom a subscription fee is received;
d. measuring the number of times the received content is accessed by other users; and
e. providing a benefit to the user from whom content is received based at least in part on the accesses by others of the content received from the user.

17. A method comprising:
a. receiving a fee from at least one user;
b. providing content to the users from whom a fee is received;
c. receiving content from at least one user from whom a fee is received;
d. receiving registration information from the users from whom content is received;
e. providing a benefit to the users from whom content is received based at least in part on the content received from the user; and
f. providing content received from the users to other users.
